(19) United States
(12) Patent Application Publication
(10) Pub. No.: US 2018/0046920 A1
(43) Pub. Date: Feb. 15, 2018

(54) User Data Learning Based on Recurrent Neural Networks with Long Short Term Memory

(71) Applicant: PAYPAL, INC., San Jose, CA (US)

(72) Inventors: Yaqin Yang, San Jose, CA (US); Fransisco Kurniadi, Dublin, CA (US); Lingyi Lu, San Jose, CA (US)

(21) Appl. No.: 15/233,083

(22) Filed: Aug. 10, 2016

(51) Int. Cl. G06N 3/08; G06N 3/04

(52) U.S. Cl. CPC G06N 3/088; G06N 3/04

(57) ABSTRACT

Various systems, mediums, and methods may perform operations, such as collecting various types of data from one or more data sources. Further, the operations may include learning user behaviors based on iterations of the collected historical data with a recurrent neural network (RNN) with long short term memory (LSTM). Yet further, the operations may include determining one or more feature vectors that represents the learned user behaviors. In addition, the operations may include generating one or more models associated with the learned user behaviors based on the one or more determined vectors.

### BACKGROUND

Machine learning of user behaviors may be important to various types of systems. For example, learning user responses to different types of notifications may be imperative to systems, such as systems configured to collect data from numerous users. However, there may be various challenges related to such systems, particularly with challenges related to machine learning. For example, some data collection systems may lack deep knowledge domains to perform machine learning operations effectively. Further, it may be difficult to develop such knowledge domains without adversely impacting user experiences. Yet further, it may be expensive to obtain such knowledge domains, since developing such domains may take time, possibly based on the bandwidth required to build the domains. Under various such circumstances, data collection systems may operate with less optimal results.

As demonstrated in the examples above, there is much need for technological advancements in various aspects of systems associated with machine learning technologies.

### BRIEF DESCRIPTION OF THE DRAWINGS

FIG. 1 is a block diagram of an exemplary system, according to an embodiment;

FIG. 2A illustrates an exemplary neural network, according to an embodiment;

FIG. 2B illustrates exemplary network nodes, according to an embodiment;

FIG. 3A illustrates an exemplary neural network, according to an embodiment;

FIG. 3B illustrates an exemplary neural network with a hidden-layer transfer, according to an embodiment;

FIG. 3C illustrates an exemplary neural network with a second hidden-layer transfer, according to an embodiment;

FIG. 3D illustrates an exemplary neural network with a third hidden-layer transfer, according to an embodiment;

FIG. 3E illustrates exemplary network nodes, according to an embodiment;

FIG. 4 illustrates an exemplary method, according to an embodiment;

FIG. 5 is a block diagram of an exemplary system, according to an embodiment;

FIG. 6A illustrates an exemplary system configured to support a set of trays, according to an embodiment;

FIG. 6B illustrates an exemplary tray configured to support one or more components, according to an embodiment; and

FIG. 7 illustrates an exemplary system with a client device, according to an embodiment.

Embodiments of the present disclosure and their advantages may be understood by referring to the detailed description herein. It should be appreciated that reference numerals may be used to illustrate various elements and features provided in the figures. The figures may illustrate various examples for purposes of illustration and explanation related to the embodiments of the present disclosure and not for purposes of any limitation.

### DETAILED DESCRIPTION

As described in the scenarios above, there may be numerous challenges to various types of systems associated with machine learning technologies. In particular, systems may face challenges with lacking the deep knowledge domains to perform operations effectively. As noted, it may be difficult to develop the knowledge domains without adversely impacting user experiences and further, it may be expensive to obtain such knowledge domains, possibly based on the time it takes to develop the domains and/or the bandwidth required to build the domains. In addition, some systems may face challenges associated with collecting data from users based on the user's behaviors. In particular, the users may generally be unavailable, the users' contact information may change, possibly where the users may change their contact information multiple times. Further, in some instances, the users may deliberately avoid being contacted and/or block attempts to contact the users, among other possibilities. In some instances, it may be challenging to identify which users to contact, when to attempt to contact the users, and/or how to make contact with the users, particularly based on the methods of communication available to make such attempts.

As such, the systems described herein may be configured to learn user behaviors for tasks without having the deep knowledge domains described above. In some instances, the user behaviors may include user actions, selections, responses, activities, logins including the number of logins, activities possibly associated with accounts, transactions, transfers, purchases, and/or various other user activities described herein. In some instances, the systems may obtain data from various data sources, such as available data sources without the deep knowledge domains, based on systems and/or architectures with recurrent neural networks (RNN) having long short term memory (LSTM). For example, one system may collect various types of data from the available data sources, such as historical data from existing data sources accessible to the system. Notable, the system may collect various types of regularly accessible data without having access to the deep knowledge domains described above. For example, the system may collect historical data that identifies which users were contacted within one or more time periods. Further, the data may indicate instances when users were contacted previously. Yet further, the data may indicate how the users were contacted based on the methods of communication described above. In addition, the system may collect user data based on user actions, user activities, and/or user responses, such as the number of times users log in to their accounts, the transactions made with their accounts, and/or the transfers made with their accounts, among other possibilities.

Further, the system may learn user behaviors, possibly where the learning may be customized iteratively using RNN with LSTM. In some instances, the system may determine a vector, such as a multi-dimensional feature vector, possibly to represent the behaviors of various users, such as the historical behaviors of the users over one or more periods of time. The vector may represent the user actions, user activities, and/or user responses described above, such as the number of logins, account activities, account transactions, account transfers, and/or various other user activities, among other possibilities. In addition, the system may apply the users' behaviors embedded in such vectors to model various risks, including risks associated with attempting to contact the users and/or collect data from the users. Thus, in some instances, the system may determine which users to contact, when to contact such users, and how the users may be contacted based on the modeled risks.

In some embodiments, the system may learn a feature matrix. For example, the learned feature matrix may represent a history of contacts with numerous users. Thus, a contact model may be determined based on the learned feature matrix, where the contact model may predict whether a user may be contacted, where the user may be contacted during one or more given times, and/or whether the user may be contacted with a given method of communication, such as a particular communication path. For example, the contact model may predict whether the user may be contacted with a given telecommunication path, a given email account, and/or an application programming interface (API) call with a mobile application on the user's mobile device, among other possibilities. Further, the contact model may predict whether a user can be contacted based on the historical data that indicates how the user responds, replies, and/or reacts to various types of contacts, communications, and/or communication attempts, such as calls to the user's mobile device, text messages to the mobile device, and/or emails to the user's account, among other possibilities. Further, the contact model may provide various indications of dependability, trustworthiness, credibility, creditworthiness, solvency, and/or risk, among other characteristics associated with the users.

In some embodiments, the contact model may be applied to other tasks as well. For example, the feature matrix may be learned such that the matrix may represent various user purchasing behaviors as well. As such, a purchase model may be determined based on the feature matrix, where the purchase model may predict user purchases, such as items the users may be interested in to purchase, the locations in which the users may make purchases, the times in which the users may make purchases, and/or the method of the transactions to make the purchases, among other possibilities. Further, the feature matrix may be learned to represent various fraudulent behaviors as well. As such, a fraud detection model may be determined based on the feature matrix, where the fraud detection model may predict fraudulent activities associated with various user accounts.

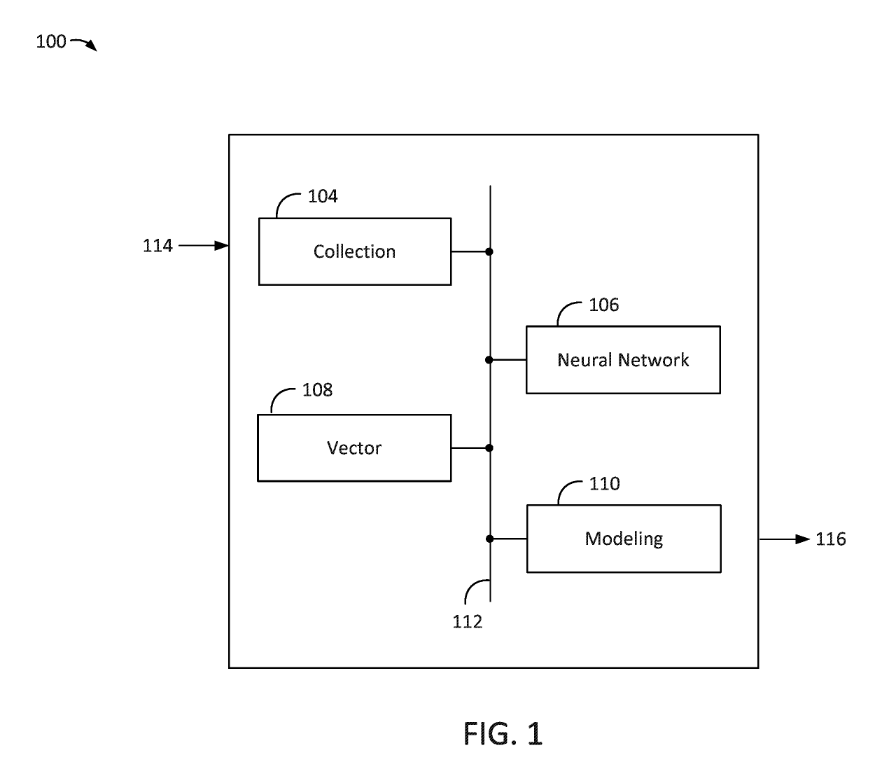

FIG. 1 is a block diagram of an exemplary system 100, according to an embodiment. As shown, the system 100 includes a collection module 104, a neural network 106 that may take the form of a recurrent neural network (RNN) with long short term memory (LSTM), a vector module 108, and a modeling module 110, among other possible modules.

In some embodiments, the collection module 104, the neural network 106, the vector module 108, and the modeling module 110 may take the form of one or more hardware components, such as a processor, an application specific integrated circuit (ASIC), a programmable system-on-chip (SOC), a field-programmable gate array (FPGA), and/or programmable logic devices (PLDs), among other possibilities. As shown, the collection module 104, the neural network 106, the vector module 108, and the modeling module 110 may be coupled to a bus, network, or other connection 112. Further, additional module components may also be coupled to the bus, network, or other connection 112. Yet, it should be noted that any two or more of the collection module 104, the neural network 106, the vector module 108, and the modeling module 110 may be combined to take the form of a single hardware component, such as the programmable SOC. In some embodiments, the system 100 may also include a non-transitory memory configured to store instructions. Yet, further the system 100 may include one or more hardware processors coupled to the non-transitory memory and configured to read the instructions to cause the system 100 to perform operations described herein.

In some embodiments, the system 100 may collect historical data 114 from one or more data sources, possibly causing the collection module 104 to collect the historical data 114 from one or more data sources. In some instances, the historical data 114 may indicate the number of contacts with the users, the method of communication and/or the communication paths with the users, the mobile applications accessed by the users, the web logins by the users, and/or other user actions and/or activities, among other possibilities. The one or more data sources may include one or more accessible data sources, possibly including one or more databases and/or data servers in communication with the system 100. As noted, the system 100 may collect the historical data 114 without the deep knowledge domains described above. Further, the system 100 may learn various user behaviors based on iterations of the collected historical data 114 with the neural network 106, possibly taking the form of a RNN with the LSTM. In some instances, the system 100 may customize the iterations with the historical data 114 based on various factors, such as the various models generated by the system 100.

Further, the system 100 may determine one or more feature vectors that represent the user behaviors learned by the system 100. For example, the vector module 108 may determine one or more feature vectors that represent the learned user behaviors, such as user responses or the lack of such responses. In some instances, the user behaviors may include user responses to various methods of communication, such as physical mail, email messages, phone calls and/or text messages, message contacts (e.g., instant messenger), and/or other communication paths associated with the users. As such, the system 100 may generate one or more models 116 that correspond to the learned user behaviors. For example, the modeling module 110 may generate one or more models 116 associated with the learned user behaviors based on the one or more determined feature vectors.

In some instances, the one or more models 116 may include a contact list that indicates a number of users that may be contacted. Yet further, in some instances, the system 100 may generate the contact list based on the one or more models 116 associated with the learned user behaviors. In some instances, the generated contact list may indicate a number of users to contact based on the one or more models 116, possibly based on the probability of reaching the users. As such, the system 100 may cause one or more mobile devices to display the contact list on the mobile device. For example, the contact list may include a ranking from a user with the highest likelihood of being contacted or reached to the user with the lowest likelihood of being contacted or reached, among other possibilities.

In some embodiments, the system 100 may generate a feature matrix based on the learned user behaviors. In some instances, the feature matrix may indicate historical contacts with one or more users. For example, the feature matrix may indicate the number of times the users have been contacted historically, the times and/or time periods in which the users were contacted, and/or the method of communication used to contact the users, possibly indicating physical mail, email messages, phone calls and/or text messages, among the other methods of contacting users described above. As such, the one or more models 116 may be generated to include a contact model, possibly also referred to as the contact model 116. The contact model 116 may be configured to predict how and when additional contacts with the one or more users may be made. For example, the contact model 116 may predict additional contacts with the users in the near future (e.g., days), the more distant future (e.g., months), and/or the greater distant future (e.g., a number of months to years).

In some embodiments, the contact model 116 may predict responses or the lack of responses of the one or more users based on the historical contacts with the users. As such, the system 100 may determine how and when the users may be contacted based on the one or more user responses or the lack of user responses. For example, the system 100 may learn when users are likely to respond based on the times and/or time periods in which the users are contacted, and/or the method of contacting the users, possibly including various methods of communication, such as physical mail, email messages and to particular email accounts, phone calls and/or text messages to particular phone numbers, among the other contact methods described above.

In some embodiments, the system 100 may generate a feature matrix based on the learned user behaviors, where the feature matrix indicates historical purchases by one or more users. For example, the feature matrix may indicate the locations where the purchases were made, the merchants and/or merchant stores in which the purchases were made, the times and/or time periods in which the users made purchases, the number of items purchased possibly based on the times and/or the time periods in which the users made the purchases, among other possibilities. As such, the one or more models generated may include a purchase model, possibly referred to as the purchase model 116. Thus, the purchase model 116 may be configured to predict additional purchases by the one or more users.

In some embodiments, the system 100 may generate a feature matrix based on the learned user behaviors, where the feature matrix indicates historical actions by one or more users. For example, the historical actions may include transactions, fund transfers, exchanges of funds, collections of funds, and/or activities associated with accounts, among other possibilities. In some instances, the historical actions may include fraudulent actions, such as gaining unauthorized accesses to one or more accounts. Further, the fraudulent actions may include performing unauthorized transactions, fund transfers, exchanges of funds, collections of funds, and/or other activities associated with user accounts. In some instances, the one or more models generated may include a detection model, possibly referred to as the detection model 116. As such, the detection model 116 may be configured to detect fraudulent actions by the one or more users.

In some embodiments, the neural network 106, possibly referred to as the recurrent neural network (RNN) 106 with long short term memory (LSTM) includes an input layer, a hidden layer, and/or an output layer, among other possible layers. In some instances, the system 100 may transfer the collected historical data 114 from the input layer to the hidden layer. As such, the collected historical data 114 may be converted to second data based on transferring the collected historical data 114 from the input layer to the hidden layer. Further, the system 100 may transfer the second data from the hidden layer to the output layer. As such, the second data may convert to third data based on transferring the second data from the hidden layer to the output layer. Yet further, the system 100 may output the third data from the output layer. Yet, in some instances, the third data may be converted to fourth data based on outputting the third data from the output layer. Thus, the system 100 may learn the user behaviors based on the third data and/or the fourth data from the output layer.

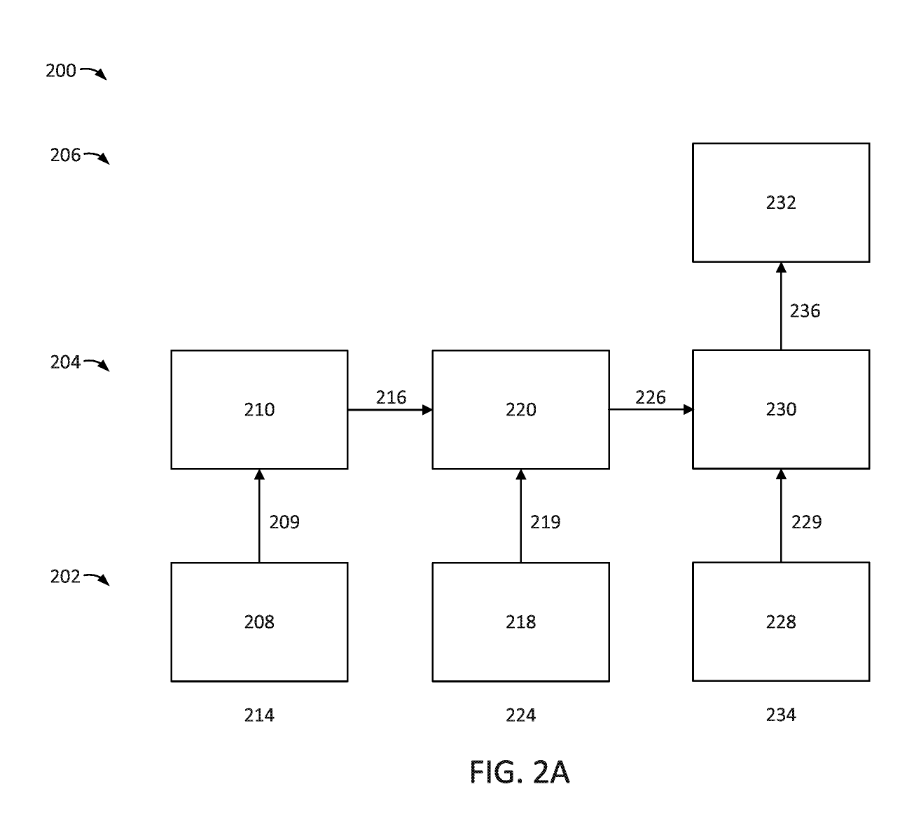

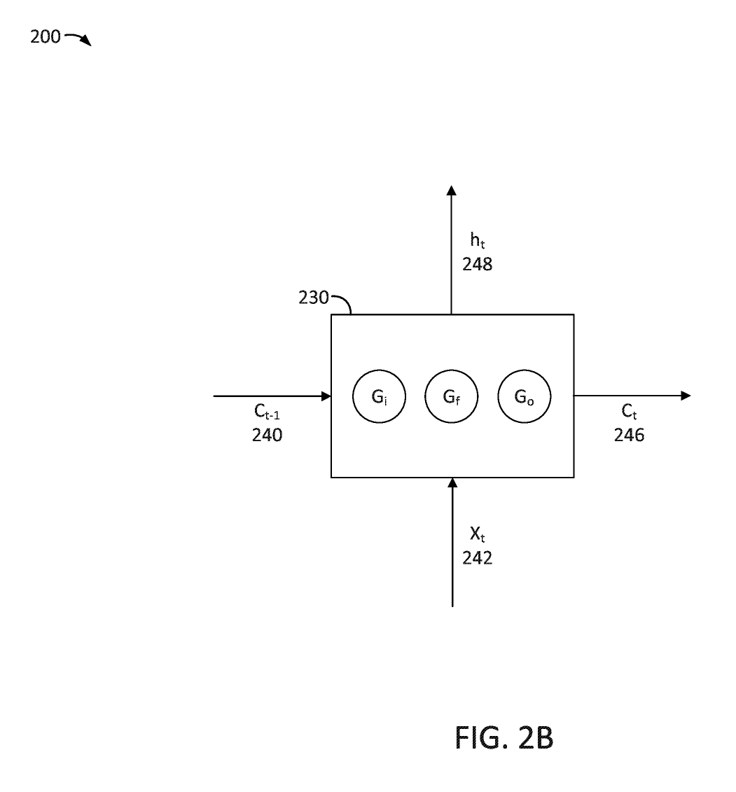

FIG. 2A illustrates an exemplary neural network 200, according to an embodiment. For example, the neural network 200 may take the form of the RNN 106 with the LSTM described above in relation to FIG. 1. As such, the neural network 200, possibly referred to as the RNN 200, may include an input layer 202, a hidden layer 204, and an output layer 206. Further, the RNN 200 may include a number of iterations 214, 224, and/or 234. In some instances, the iterations 214, 224, and/or 234 may occur at different times. For example, the iteration 214 may occur, followed by the iteration 224, and then followed by the iteration 234. In one scenario, the iteration 214 may represent fourteen days prior from the present time, the iteration 224 may represent ten days from the present time, and the iteration 234 may represent one day prior from the present time, among other possibilities. Yet, in some instances, the iterations 214, 224, and/or 234 may occur substantially simultaneously, among other possibilities.

In some embodiments, the first input nodes 208, the second input nodes 218, and/or the third input nodes 228 may receive input data, such as the collected data 114 described above. For example, the first input nodes 208 may receive a first portion of the collected data 114, the second input nodes 218 may receive a second portion of the collected data 114, and/or the third input nodes 228 may a third portion of the collected data 114. As such, the RNN 200 may determine a first input-layer transfer 209 from the first input nodes 208 to the first hidden nodes 210 of the first iteration 214. Further, the RNN 200 may determine a first hidden-layer transfer 216 from the first hidden nodes 210 of the first iteration 214 to the second hidden nodes 220 of the second iteration 224. In some instances, the first hidden nodes 210 may generate data for the first hidden-layer transfer 216 based on the first input-layer transfer 209 from the first input nodes 208. Yet further, the RNN 200 may determine a second input-layer transfer 219 from the second input nodes 218 of the second iteration 224 to the second hidden nodes 220 of the second iteration 224. Thus, the second hidden nodes 220 may generate data for the second hidden-layer transfer 226 based on the first hidden-layer transfer 216 and/or the second input-layer transfer 219 from the second input nodes 218.

In some embodiments, the RNN 200 may determine a second hidden-layer transfer 226 from the second hidden nodes 220 to third hidden nodes 230 of the third iteration 234. Further, the RNN 200 may determine a third input-layer transfer 229 from the third input nodes 228 of the third iteration 234 to the third hidden nodes 230 of the third iteration 234. Thus, the third hidden nodes 230 may generate data for the output transfer 236 based on the second hidden-layer transfer 226 and/or the third input-layer transfer 229 from the third input nodes 228. In some embodiments, the RNN 200 may determine an output transfer 236 from the third hidden nodes 230 to output nodes 232 of the third iteration 234. As such, the RNN 200 may learn user behaviors based on the output transfer 236 from the third hidden nodes 230 to the output nodes 232.

Notably, the input nodes 208, 218, and/or 228, the hidden nodes 210, 220, and/or 230, and the output nodes 232 may include a number of edges between the nodes. For example, consider a first node, a second node, and a first edge between the first node and the second node. The first edge may correspond with a given weight, such that the output from the first node is multiplied by the given weight and transferred to the second node. Yet further, consider a third node and second edge between the second node and the third node. In such instances, the second edge may correspond to a given weight, possibly different from the weight of the first edge. As such, the output from the second node may be multiplied by the weight associated with the second edge and transferred to the third node, and so on. As such, the weights associated with the input nodes 208, 218, and/or 228, the hidden nodes 210, 220, and/or 230, and the output nodes 232 may vary as the network 200 learns the various user behaviors.

FIG. 2B illustrates exemplary network nodes 230, according to an embodiment. As shown, the neural network 200 may include the network nodes 230 that take the form of the third hidden nodes 230 described above in relation to FIG. 2A. In some embodiments, various forms of data may be transferred to the third hidden nodes 230.

In some embodiments, the third hidden nodes 230 may receive a first cell state 240, shown as Cₜ₋₁, based on the second hidden-layer transfer 226 from the second hidden nodes 220 to the third hidden nodes 230. Further, the third hidden nodes 230 may receive an input 242, shown as xₜ, based on a third input-layer transfer 229 from the third input nodes 228 to the third hidden nodes 230. Yet further, the third hidden nodes 230 may determine a second cell state 246, shown as Cₜ, based on the first cell state 240 and the input 242 from the third input nodes 228, where the output transfer 236 may be determined based on the second cell state 246. In addition, the third hidden nodes 230 may generate an output 248, shown as hₜ, based on the input 242. As shown, the third hidden nodes 230 may include various sub layers, shown as the input sub layer Gᵢ, the hidden sub layer G_{f}, and the output sub layer Gₒ.

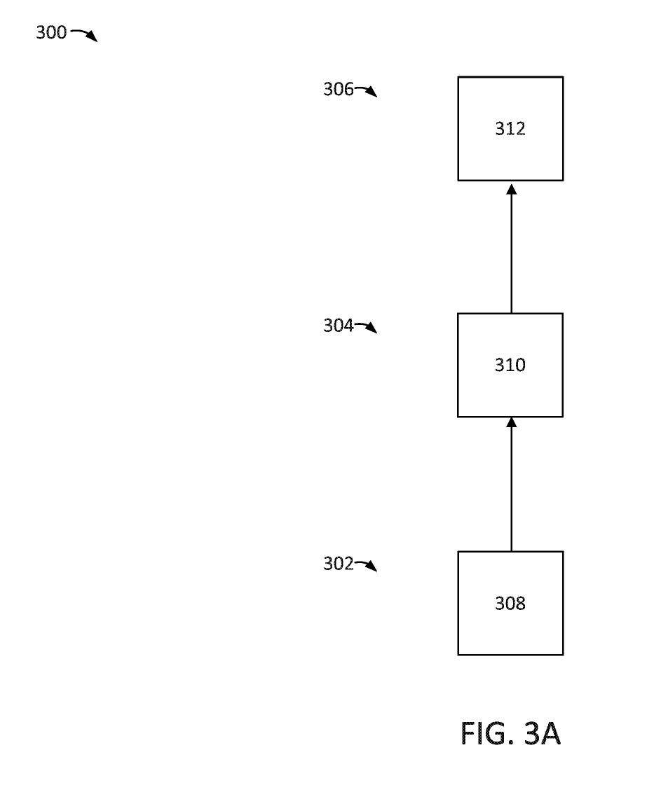

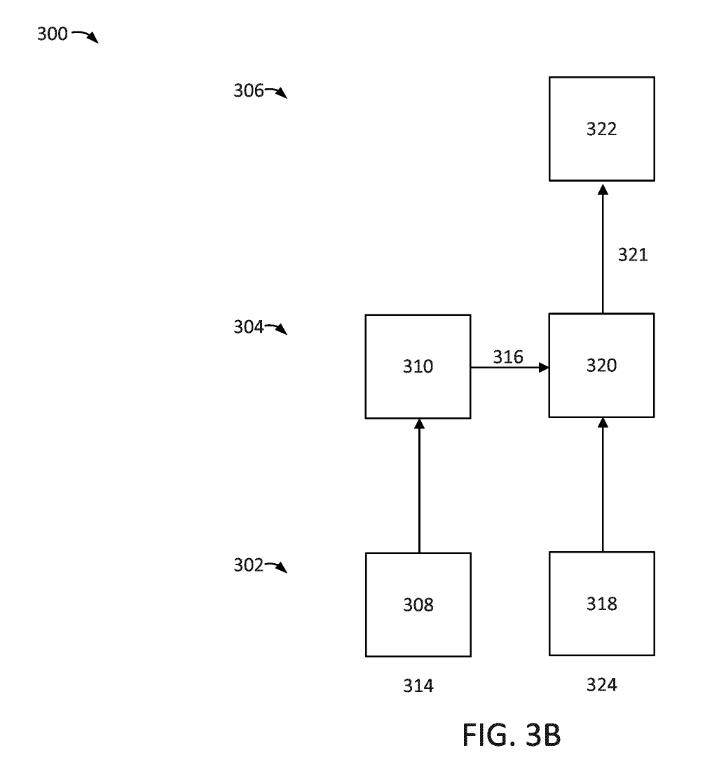

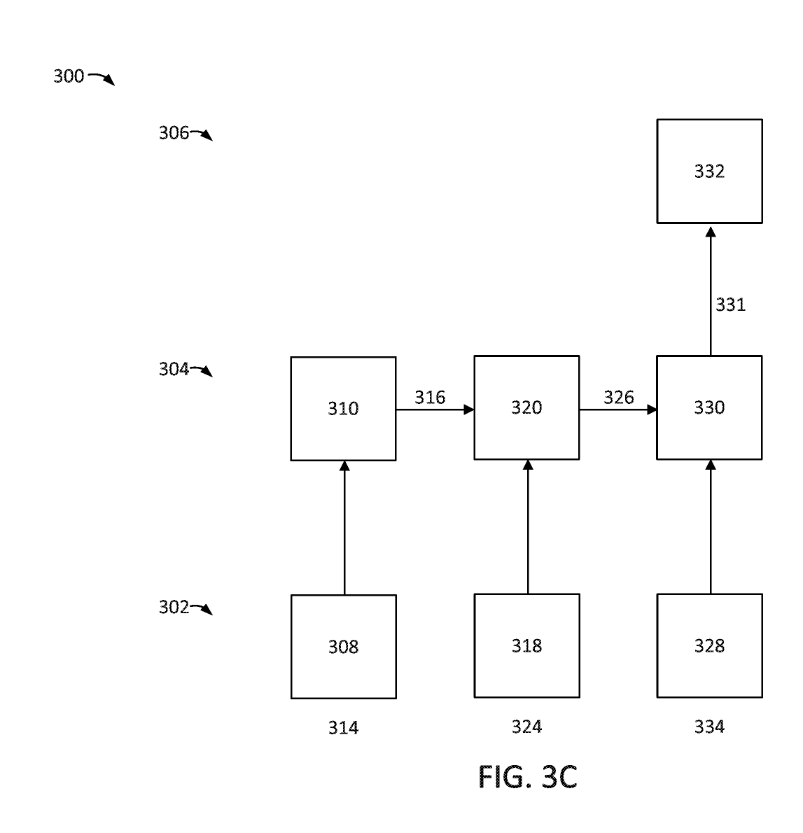

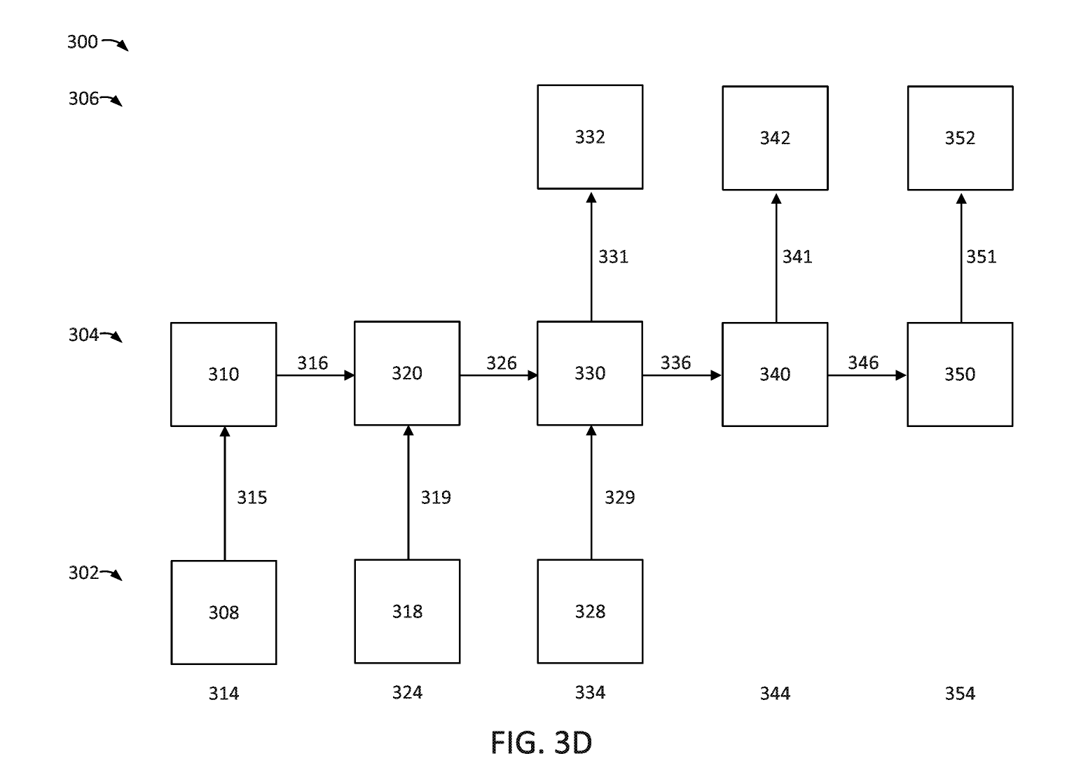

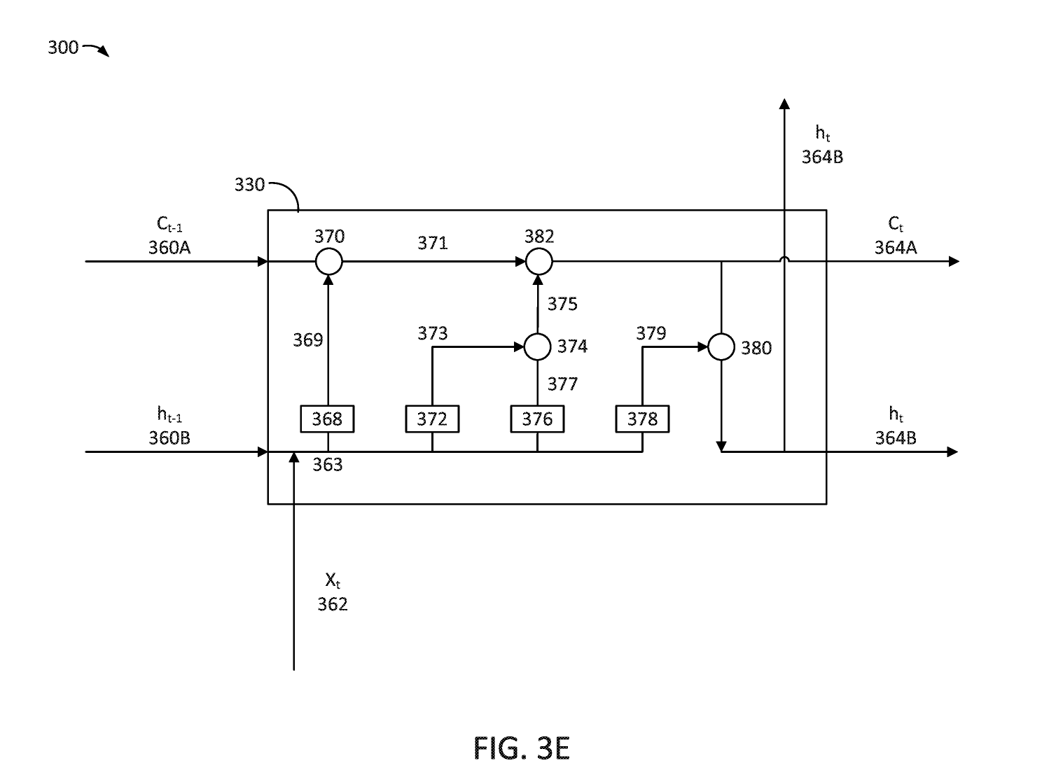

FIG. 3A illustrates an exemplary neural network 300, according to an embodiment. As shown, the neural network 300 may include aspects of the neural network 200 described above in relation FIGS. 2A and/or 2B. For example, the neural network 300 includes an input layer 302 that may take the form of the input layer 202 described above. Further, the neural network 300 includes a hidden layer 304 that may take the form of the hidden layer 204 described above. Yet further, the neural network 300 includes an output layer 306 that may take the form of the output layer 206 described above. In addition, as shown, the neural network 300 includes the input nodes 308, the hidden nodes 310, and the output nodes 312, among other possible nodes.

FIG. 3B illustrates an exemplary neural network 300 with a hidden-layer transfer 316, according to an embodiment. As shown, the neural network 300, possibly referred to as a recurrent neural network (RNN) 300 with the long short term memory (LSTM), may include aspects of the RNN 200 described above in relation to FIGS. 2A and 2B. For example, the RNN 300 may include the input layer 302, the hidden layer 304, and/or the output layer 306 described above. Further, the RNN 300 may include the first input nodes 308 and the first hidden nodes 310 in the first iteration 314. Yet further, the RNN 300 may perform the first hidden-layer transfer 316 from the first hidden nodes 310 to the second hidden nodes 320. Notably, the RNN 300 may include second input nodes 318, the second hidden nodes 320, and the output nodes 322 in a second iteration 324. As such, the RNN 300 may perform the output transfer 321 from the second hidden nodes 320 to the output nodes 322. As such, the RNN 300 may learn various user behaviors based on one or more models generated with the output nodes 322. For example, the one or more models described above may be generated with output data from the output nodes 322.

FIG. 3C illustrates an exemplary neural network 300 with a second hidden-layer transfer 326, according to an embodiment. As shown, the RNN 300 with the LSTM may include the input layer 302, the hidden layer 304, and/or the output layer 306 described above. Further, the RNN 300 may include the first input nodes 308 and the first hidden nodes 310 in the first iteration 314. Yet further, the RNN 300 may perform the first hidden-layer transfer 316 from the first hidden nodes 310 to the second hidden nodes 320. Notably, the RNN 300 may include second input nodes 318 and the second hidden nodes 320 in the second iteration 324. Yet further, the RNN 300 may perform the second hidden-layer transfer 326 from the second hidden nodes 320 to the third hidden nodes 330. Notably, the RNN 300 may include third input nodes 328, the third hidden nodes 330, and the output nodes 332 in a third iteration 334. As such, the RNN 300 may learn various user behaviors based on one or more models generated with the output transfer 331 from the third hidden nodes 330 to the output layer 332. For example, the one or more models described above may be generated with output data from the output nodes 332.

FIG. 3D illustrates an exemplary neural network 300 with a third hidden-layer transfer 336, according to an embodiment. As shown, the RNN 300 with the LSTM may include the input layer 302, the hidden layer 304, and/or the output layer 306 described above. Further, the RNN 300 may include the first input nodes 308 and the first hidden nodes 310 in the first iteration 314. Yet further, the RNN 300 may determine the first hidden-layer transfer 316 from the first hidden nodes 310 of the first iteration 314 to the second hidden nodes 320 of the second iteration 324. In addition, the RNN 300 may generate data for the first hidden-layer transfer 316 based on the first input transfer 315. Notably, the RNN 300 may include the second input nodes 318 and the second hidden nodes 320 in the second iteration 324.

Yet further, the RNN 300 may determine the second hidden-layer transfer 326 from the second hidden nodes 320 to the third hidden nodes 330 of the third iteration 334. In addition, the RNN 300 may determine a first output transfer 331 from the third hidden nodes 330 to third output nodes 332 of the third iteration 334. As such, the RNN 300 may learn various user behaviors based on one or more models generated with the output nodes 332. For example, the one or more models may be generated with output data from the output nodes 332. Notably, the RNN 300 may include third input nodes 328, the third hidden nodes 330, and the output nodes 332 from the third iteration 334. In some instances, the RNN 300 may generate data for the first output transfer 331 based on the second hidden-layer transfer 326 and a third input transfer 329 from the third input nodes 328 to the third hidden nodes 330 of the third iteration 334. As such, the RNN 300 may learn user behaviors based on the first output transfer 331 from the third hidden nodes 330 to third output nodes 332. For example, the one or more models described above may be generated with output data from the third output nodes 332.

In some embodiments, the RNN 300 may determine a third hidden-layer transfer 336 from the third hidden nodes 330 to fourth hidden nodes 340 of a fourth iteration 344. Further, the RNN 300 may determine a second output transfer 341 from the fourth hidden nodes 340 to fourth output nodes 342 of the fourth iteration 344. In some instances, the RNN 300 may generate data for the second output transfer 341 based on the third hidden-layer transfer 336. As such, the RNN 300 may learn user behaviors based on the second output transfer 341 from fourth hidden nodes 340 to fourth output nodes 342. For example, the one or more models described above may be generated with output data from the output nodes 342.

In some embodiments, the RNN 300 may determine a fourth hidden layer transfer 346 from the fourth hidden nodes 340 to fifth hidden nodes 350 of a fifth iteration 354. Further, the RNN 300 may determine a third output transfer 351 from the fifth hidden nodes 350 to fifth output nodes 352 of the fifth iteration 354. As such, the RNN 300 may learn user behaviors based on the third output transfer 351 from the fifth hidden nodes 350 to fifth output nodes 352. For example, the one or more models described above may be generated with output data from the output nodes 352.

FIG. 3E illustrates exemplary network nodes 330, according to an embodiment. As shown, the neural network 300 may include the network nodes 330 that take the form of the third hidden nodes 230 described above in relation to FIGS. 2A and 2B, and/or further the third hidden nodes 330 described above in relation FIGS. 3C and 3D. In some embodiments, various forms of data may be transferred to the third hidden nodes 330.

In some embodiments, the third hidden nodes 330 may receive a first cell state 360A, shown as Cₜ₋₁, that may take the form of the first cell state 240 described above. Further, the third hidden nodes 330 may receive the input 360B, shown as hₜ₋₁. In some instances, the first cell state 360A and/or the input 360B may be received based on the second hidden-layer transfer 326 from the second hidden nodes 320 to the third hidden nodes 330. Yet further, the third hidden nodes 330 may receive an input 362, shown as xₜ, that may take the form of the input 242. The input 362 may be received based on the third input-layer transfer 329 from the third input nodes 328 to the third hidden nodes 330, as described above.

As shown, the input 360B and the input 362 may be concatenated such that the concatenated input 363 is transferred to the sigmoid layers 368, 372, and 378, and also the tan h layer 376. The sigmoid output 369 from the sigmoid layer 368 may be represented by fₜ in the following:

fₜ=σ(W_{f}·[hₜ₋₁,xₜ]+b_{f})

As such, the third hidden nodes 330 may transfer the first cell state 360A to the one or more pointwise operations 370 based on the second hidden layer transfer 326. Further, the third hidden nodes 330 may determine the second cell state 364A based on the first cell state 360A transferred to the one or more pointwise operations 370 and further based on one or more layers 368, 372, 376, and/or 378 of the third hidden nodes 330. In particular, the sigmoid output 369 may be transferred to the pointwise operation 370 with the first cell state 360A. The pointwise operation 370 may perform a multiplication operation with the sigmoid output 369 and the first cell state 360 to produce the operation output 371.

The sigmoid output 373 from the sigmoid layer 372 and the tan h output 377 from the tan h layer 376 are transferred to the pointwise operation 374, possibly also a multiplication operation, to produce the operation output 375. The sigmoid output 373 may be represented as iₜ and the tan h output 377 may be represented as C′ₜ in the following:

iₜ=σ(W₁·[hₜ₋₁,xₜ]+bᵢ)

C′ₜ=tan h(W_{c}·[hₜ₋₁,xₜ]+b_{c})

The pointwise operation 382 may perform an addition operation with the operation outputs 371 and 375 to produce the second cell state 364A. In particular, based on the sigmoid output 369 (fₜ), the sigmoid output 373 (iₜ), and the tan h output 377 (C′ₜ), and the first cell state 360A (Cₜ₋₁), the second cell state 364A is determined. The second cell state 364A is represented by Cₜ in the following:

Cₜ=fₜ*Cₜ₋₁+iₜ*C′ₜ

Further, the sigmoid output 379 from the sigmoid layer 379 may be represented by oₜ in the following:

oₜ=(Wₒ·[hₜ₋₁,xₜ]+bₒ)

As such, the sigmoid output 379 and the second cell state 364 is transferred to the pointwise operation 380, a multiplication operation, to provide the output 364B represented as hₜ in the following:

hₜ=o_{f}*tan h(C_{f})

As such, the user behaviors may be learned based on the output 364B and/or the second cell state 364A.

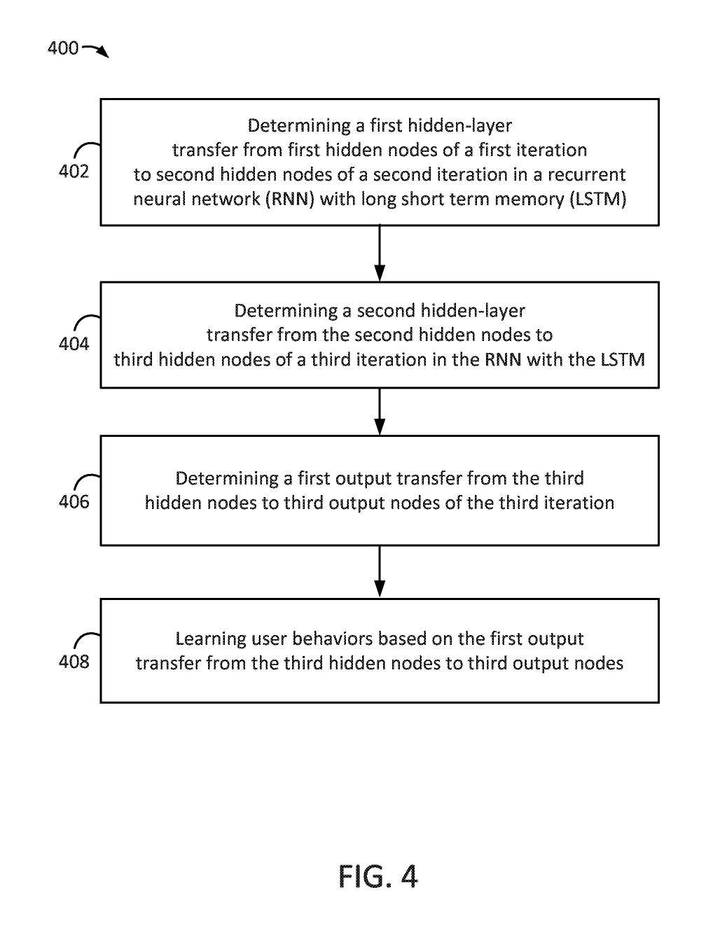

FIG. 4 illustrates an exemplary method 400, according to an embodiment. Notably, one or more steps of the method 400 described herein may be omitted, performed in a different sequence, and/or combined with other methods for various types of applications contemplated herein.

At step 402, the method 400 may include determining a first hidden-layer transfer from first hidden nodes of a first iteration to second hidden nodes of a second iteration in a recurrent neural network (RNN) with long short term memory (LSTM). For example, referring back to FIG. 3D, the method 400 may include determining the first hidden-layer transfer 316 from the first hidden nodes 310 of the first iteration 314 to the second hidden nodes 320 of the second iteration 324 in the RNN 300 with the LSTM.

At step 404, the method 400 may determining a second hidden-layer transfer from the second hidden nodes to third hidden nodes of a third iteration in the RNN with the LSTM. For example, referring back to FIG. 3D, the method 400 may include determining the second hidden-layer transfer 326 from the second hidden nodes 320 to the third hidden nodes 330 of the third iteration 334 in the RNN 300 with the LSTM.

At step 406, the method 400 may include determining a first output transfer from the third hidden nodes to third output nodes of the third iteration. For example, referring back to FIG. 3D, the method 400 may include determining a first output transfer 331 from the third hidden nodes 330 to third output nodes 332 of the third iteration 334.

At step 408, the method 400 may include learning user behaviors based on the first output transfer from the third hidden nodes to third output nodes. For example, referring back to FIG. 3D, the method 400 may include learning user behaviors based on the first output transfer 331 from the third hidden nodes 330 to third output nodes 332. In particular, the user behaviors may be learned from the output data from the third output nodes 332.

In some embodiments, the method 400 may include generating output data for the first output transfer 331 based on the second hidden-layer transfer 326 and the third input transfer 329 from third input nodes 328 to the third hidden nodes 330 of the third iteration 334. As noted, referring back to FIG. 3E, the output data may include the output 364B described above.

In some embodiments, the method 400 may include determining the third hidden-layer transfer 336 from the third hidden nodes 330 to fourth hidden nodes 340 of a fourth iteration 344 in the RNN 300 with the LSTM. Further, the method 400 may include determining the second output transfer 341 from the fourth hidden nodes 340 to fourth output nodes 342 of the fourth iteration 344. In some instances, the user behaviors may be learned based on the second output transfer 341 from the fourth hidden nodes 340 to the fourth output nodes 342. In particular, the user behaviors may be learned from the output data from the fourth output nodes 342.

In some embodiments, the method 400 may include determining the fourth hidden layer transfer 346 from the fourth hidden nodes 340 to the fifth hidden nodes 350 of the fifth iteration 354 in the RNN 300 with the LSTM. Further, the method 400 may include determining a third output transfer 351 from the fifth hidden nodes 350 to fifth output nodes 352 of the fifth iteration 354. As such, the user behaviors may be learned based on the third output transfer 351 from the fifth hidden nodes 350 to fifth output nodes 352. In particular, the user behaviors may be learned from the output data from the fifth output nodes 352.

In some embodiments, the method 400 may include determining a third output transfer 351 from the fifth hidden nodes 350 to fifth output nodes 352 of the fifth iteration 354. As such, the user behaviors may be learned based on the third output transfer 351 from the fifth hidden nodes 350 to fifth output nodes 352.

In some embodiments, the method 400 may include transferring the first cell state 360A described above to one or more pointwise operations 370 based on the second hidden-layer transfer 326. Further, the method 400 may include determining a second cell state 364A based on the first cell state 360A transferred to the one or more pointwise operations 370. Yet further, the second cell state 364A may be determined based on the one or more layers 368, 372, 376, and/or 378 of the third hidden nodes 330. Yet further, the second cell state 364A may be determined based on the one or more pointwise operations 374 and/or 382, as described above. As such, the user behaviors may be learned based on the second cell state 364A and/or the output 364B. For example, the method 400 may include generating a contact list associated with the learned user behaviors based on output data from the output nodes 332, 342, and/or 352. Further, the method 400 may include displaying the contact list on a mobile device. In some instances, the generated contact list may indicate a number of users to contact based on the one or more models 116 described above in relation to FIG. 1, possibly ranking the users from users most likely to be reached to users least likely to be reached.

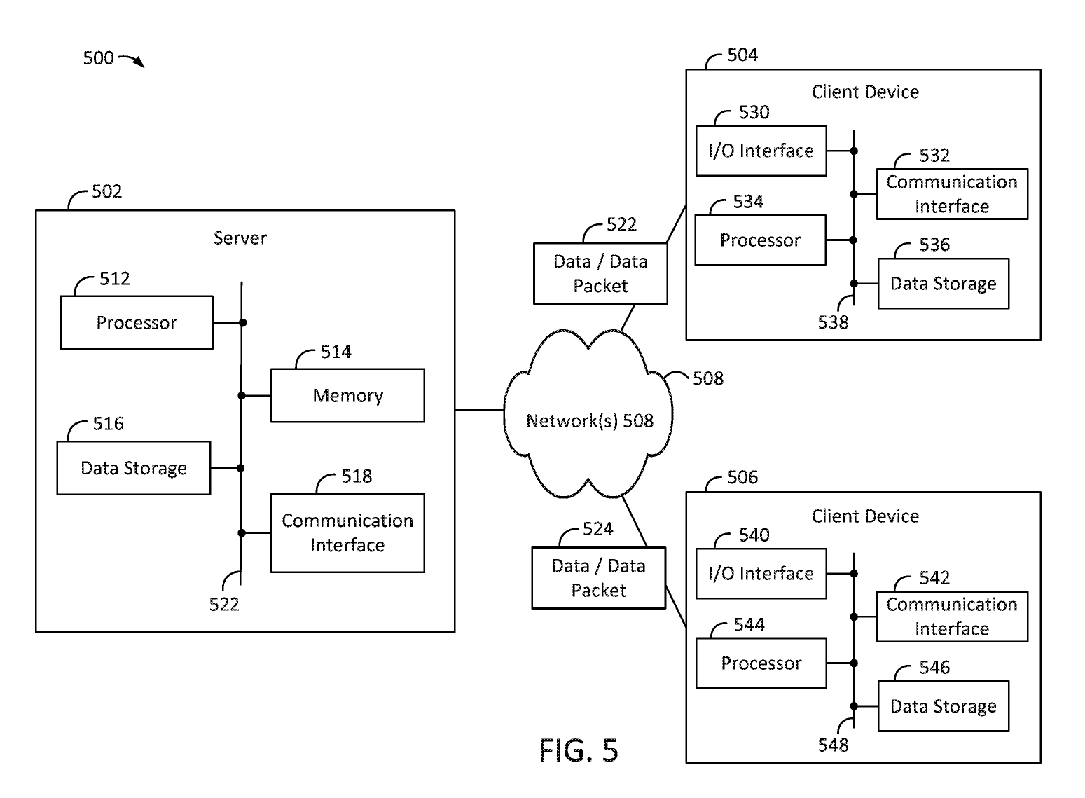

FIG. 5 is a block diagram of an exemplary system 500, according to an embodiment. The system 500 may include the system 100 described above in relation to FIG. 1 and the neural networks 200 and/or 300 described above in relation to FIGS. 2A-3E, possibly taking the form of RNNs 200 and/or 300. For example, as shown in FIG. 5, the system 500 includes the server 502. The server 502 may include aspects the system 100 such as the collection module 104, the neural network 106, the vector module 108, and/or the modeling module 110 described above. The server 500 may be configured to perform operations of a service provider, such as PayPal, Inc. of San Jose, Calif., USA. Further, the system 500 may also include client device 504 and the client device 506. As such, the server 502 and the client devices 504 and 506 may be configured to communicate over the one or more communication networks 508. As shown, the system 500 includes multiple computing devices but may also include other possible computing devices as well.

The system 500 may operate with more or less than the computing devices shown in FIG. 5, where each device may be configured to communicate over the one or more communication networks 508, possibly to transfer data accordingly. In some instances, the one or more communication networks 508 may include a data network, a telecommunications network, such as a cellular network, among other possible networks. In some instances, the communication network 508 may include web servers, network adapters, switches, routers, network nodes, base stations, microcells, and/or various buffers/queues to transfer data/data packets 522 and/or 524.

The data/data packets 522 and/or 524 may include the various forms of data associated with the one or more users described above. The data/data packets 522 and/or 524 may be transferable using communication protocols such as packet layer protocols, packet ensemble layer protocols, and/or network layer protocols, among other protocols and/or communication practices. For example, the data/data packets 522 and/or 524 may be transferable using transmission control protocols and/or internet protocols (TCP/IP). In various embodiments, each of the data/data packets 522 and 524 may be assembled or disassembled into larger or smaller packets of varying sizes, such as sizes from 5,000 to 5,500 bytes, for example, among other possible data sizes. As such, data/data packets 522 and/or 524 may be transferable over the one or more networks 508 and to various locations in the data infrastructure 500.

In some embodiments, the server 502 may take a variety of forms. The server 502 may be an enterprise server, possibly operable with one or more operating systems to facilitate the scalability of the data infrastructure 500. For example, the server 502 may operate with a Unix-based operating system configured to integrate with a growing number of other servers, client devices 504 and/or 506, and other networks 508. The server 502 may further facilitate workloads associated with numerous contacts with users. In particular, the server 502 may facilitate the scalability relative to such increasing number of contacts with users to eliminate data congestion, bottlenecks, and/or transfer delays.

In some embodiments, the server 502 may include multiple components, such as one or more hardware processors 512, non-transitory memories 514, non-transitory data storages 516, and/or communication interfaces 518, among other possible components described above in FIG. 1, any of which may be communicatively linked via a system bus, network, or other connection mechanism 522. The one or more hardware processors 512 may take the form of a multi-purpose processor, a microprocessor, a special purpose processor, a digital signal processor (DSP) and/or other types of processing components. For example, the one or more hardware processors 512 may include an application specific integrated circuit (ASIC), a programmable system-on-chip (SOC), and/or a field-programmable gate array (FPGA). In particular, the one or more hardware processors 512 may include a variable-bit (e.g., 64-bit) processor architecture configured for generating one or more results with the neural networks described above. As such, the one or more hardware processors 512 may execute varying instructions sets (e.g., simplified and complex instructions sets) with fewer cycles per instruction than other general-purpose hardware processors to improve the performance of the server 502.

In practice, for example, the one or more hardware processors 512 may be configured to read instructions from the non-transitory memory component 514 to cause the system 500 to perform operations. Referring back to FIG. 1, the operations may include collect historical data 114 from one or more data sources. The operations may also include determining one or more feature vectors that represent the learned user behaviors. The operations may include generating one or more models 116 associated with the learned user behaviors.

The non-transitory memory component 514 and/or the non-transitory data storage 516 may include one or more volatile, non-volatile, and/or replaceable storage components, such as magnetic, optical, and/or flash storage that may be integrated in whole or in part with the one or more hardware processors 512. Further, the memory component 514 may include or take the form of a non-transitory computer-readable storage medium, having stored thereon computer-readable instructions that, when executed by the hardware processing component 512, cause the server 502 to perform operations described above and also those described in this disclosure, illustrated by the accompanying figures, and/or otherwise contemplated herein.

The communication interface component 518 may take a variety of forms and may be configured to allow the server 502 to communicate with one or more devices, such as the client devices 504 and/or 506. For example, the communication interface 518 may include a transceiver that enables the server 502 to communicate with the client devices 504 and/or 506 via the one or more communication networks 508. Further, the communication interface 518 may include a wired interface, such as an Ethernet interface, to communicate with the client devices 504 and/or 506. Yet further, the communication interface 518 may include a wireless interface, a cellular interface, a Global System for Mobile Communications (GSM) interface, a Code Division Multiple Access (CDMA) interface, and/or a Time Division Multiple Access (TDMA) interface, among other types of cellular interfaces. In addition, the communication interface 518 may include a wireless local area network interface such as a WI-FI interface configured to communicate with a number of different protocols. As such, the communication interface 518 may include a wireless interface operable to transfer data over short distances utilizing short-wavelength radio waves in approximately the 2.4 to 2.485 GHz range. In some instances, the communication interface 518 may send/receive data or data packets 522 and/or 524 to/from client devices 504 and/or 506.

The client devices 504 and 506 may also be configured to perform a variety of operations such as those described in this disclosure, illustrated by the accompanying figures, and/or otherwise contemplated herein. In particular, the client devices 504 and 506 may be configured to transfer data/data packets 522 and/or 524 with the server 502, that include data associated with one or more users. The data/data packets 522 and/or 524 may also include location data such as Global Positioning System (GPS) data or GPS coordinate data, triangulation data, beacon data, WI-FI data, peer data, social media data, phone data, text message data, email data, and/or other forms of contact data, among other data related to possible characteristics communication with users described or contemplated herein.

In some embodiments, the client devices 504 and 506 may include or take the form of a smartphone system, a personal computer (PC) such as a laptop device, a tablet computer device, a wearable computer device, a head-mountable display (HMD) device, a smart watch device, and/or other types of computing devices configured to transfer data. The client devices 504 and 506 may include various components, including, for example, input/output (I/O) interfaces 530 and 540, communication interfaces 532 and 542, hardware processors 534 and 544, and non-transitory data storages 536 and 546, respectively, all of which may be communicatively linked with each other via a system bus, network, or other connection mechanisms 538 and 548, respectively.

The I/O interfaces 530 and 540 may be configured to receive inputs from and provide outputs to one or more users of the client devices 504 and 506. For example, the I/O interface 530 may include a display that renders a graphical user interface (GUI) configured to receive user inputs. Thus, the I/O interfaces 530 and 540 may include displays and/or other input hardware with tangible surfaces such as touchscreens with touch sensitive sensors and/or proximity sensors. The I/O interfaces 530 and 540 may also be synched with a microphone configured to receive voice commands, a computer mouse, a keyboard, and/or other input mechanisms. In addition, I/O interfaces 530 and 540 may include output hardware, such as one or more touchscreen displays, sound speakers, other audio output mechanisms, haptic feedback systems, and/or other hardware components.

In some embodiments, communication interfaces 532 and 542 may include or take a variety of forms. For example, communication interfaces 532 and 542 may be configured to allow client devices 504 and 506, respectively, to communicate with one or more devices according to a number of protocols described or contemplated herein. For instance, communication interfaces 532 and 542 may be configured to allow client devices 504 and 506, respectively, to communicate with the server 502 via the communication network 508. The processors 534 and 544 may include one or more multi-purpose processors, microprocessors, special purpose processors, digital signal processors (DSP), application specific integrated circuits (ASIC), programmable system-on-chips (SOC), field-programmable gate arrays (FPGA), and/or other types of processing components.

The data storages 536 and 546 may include one or more volatile, non-volatile, removable, and/or non-removable storage components, and may be integrated in whole or in part with processors 534 and 544, respectively. Further, data storages 536 and 546 may include or take the form of non-transitory computer-readable mediums, having stored thereon instructions that, when executed by processors 534 and 544, cause the client devices 504 and 506 to perform operations, respectively, such as those described in this disclosure, illustrated by the accompanying figures, and/or otherwise contemplated herein.

In some embodiments, the one or more communication networks 508 may be used to transfer data between the server 502, the client device 504, the client device 506, and/or other computing devices associated with the data infrastructure 500. The one or more communication networks 508 may include a packet-switched network configured to provide digital networking communications and/or exchange data of various forms, content, type, and/or structure. The communication network 508 may include a data network such as a private network, a local area network, and/or a wide area network. Further, the communication network 508 may include a cellular network with one or more base stations and/or cellular networks of various sizes.

In some embodiments, the client device 504 may generate a request to determine a list of users, possibly a list of users that may be contacted at a given time or time period. For example, the request may be encoded in the data/data packet 522 to establish a connection with the server 502. As such, the request may initiate a search of an internet protocol (IP) address of the server 502 that may take the form of the IP address, “192.168.1.102,” for example. In some instances, an intermediate server, e.g., a domain name server (DNS) and/or a web server, possibly in the one or more networks 508 may identify the IP address of the server 502 to establish the connection between the client device 504 and the server 502. As such, the server 502 may generate the requested list of users to contact, possibly based on the data/data packet 522 exchanged.

It can be appreciated that the server 502 and the client devices 504 and/or 506 may be deployed in various other ways. For example, the operations performed by the server 502 and/or the client devices 504 and 506 may be performed by a greater or a fewer number of devices. Further, the operations performed by two or more of the devices 502, 504, and/or 506 may be combined and performed by a single device. Yet further, the operations performed by a single device may be separated or distributed among the server 502 and the client devices 504 and/or 506. In addition, it should be noted that the client devices 504 and/or 506 may be operated and/or maintained by the same users. Yet further, the client devices 504 and/or 506 may be operated and/or maintained by different users such that each client device 504 and/or 506 may be associated with one or more accounts.

Notably, one or more accounts may be displayed on the client device 504, possibly through I/O interface 530. Thus, the account may be displayed on a smartphone system and/or any of the devices described or contemplated herein to access the account. For example, a user may manage one or more of their accounts on the client device 504.

Further, it should be noted a user account may take a number of different forms. For example, the user account may include a compilation of data associated with a given user. For example, an account for a particular user may include data related to the user's interest. Some examples of accounts may include accounts with service providers described above and/or other types of accounts with funds, balances, and/or check-outs, such as e-commerce related accounts. Further, accounts may also include social networking accounts, email accounts, smartphone accounts, music playlist accounts, video streaming accounts, among other possibilities. Further, the user may provide various types of data to the account via the client device 504.

In some embodiments, an account may be created for one or more users. In some instances, the account may be a corporate account, where employees, staff, worker personnel, and/or contractors, among other individuals may have access to the corporate account. Yet further, it should be noted that a user, as described herein, may be a number of individuals or even a robot, a robotic system, a computing device, a computing system, and/or another form of technology capable of transferring data corresponding to the account. The user may be required to provide a login, a password, a code, an encryption key, authentication data, and/or other types of data to access to the account. Further, an account may be a family account created for multiple family members, where each member may have access to the account.

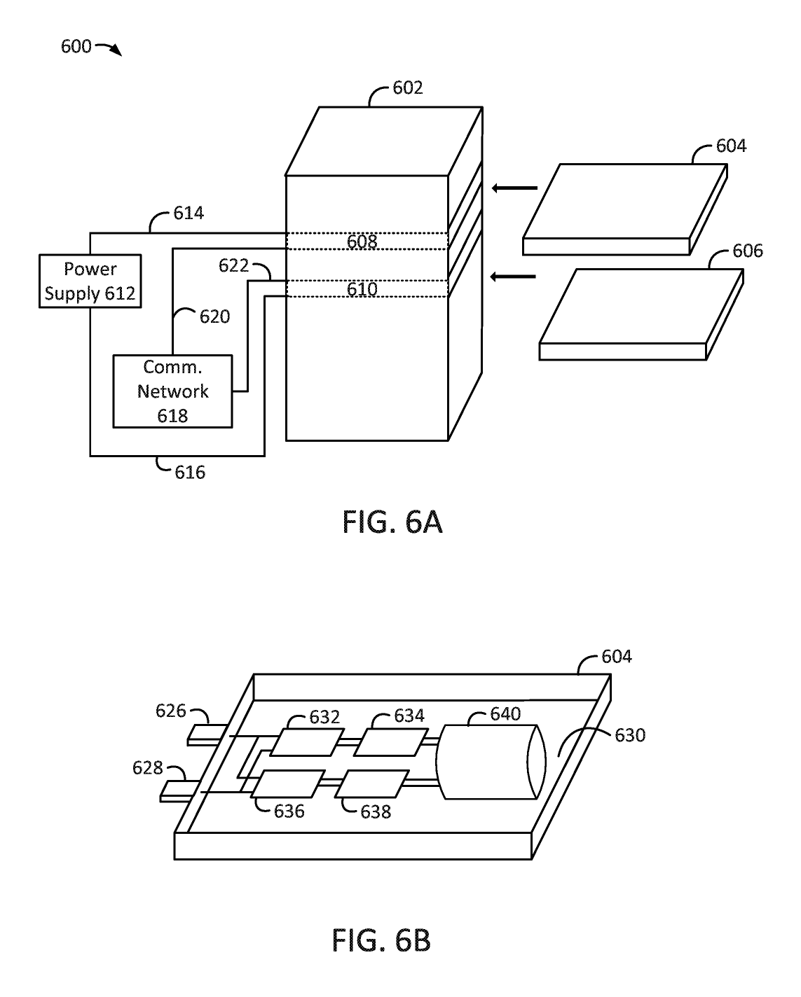

FIG. 6A illustrates exemplary system 600 configured to support a set of trays 604 and 606, according to an embodiment. The system 600 may, for example, include or take the form of the server 502 described above in relation to FIG. 5, possibly including the system 100 described in relation to FIG. 1. In particular, the system 600 may also be referred to as the server or server system 600. As such, the server system 600 may receive requests from numerous client devices, such as the client devices 504 and/or 506, to generate lists of users to contact. The system 600 may further support, operate, run, and/or manage the applications, websites, platforms, and/or other compilations of data to generate lists of users to contact.

As shown, the system 600 may include a chassis 602 that may support trays 604 and 606, possibly also referred to as servers or server trays 604 and/or 606. Notably, the chassis 602 may support multiple other trays as well. The chassis 602 may include slots 608 and 610, among other possible slots, configured to hold or support trays 604 and 606, respectively. For example, the tray 604 may be inserted into the slot 608 and the tray 606 may be inserted into the slot 610. Yet, the slots 608 and 610 may be configured to hold the trays 604 and 606 interchangeably such that the slot 608 may be configured to hold the tray 606 and the slot 610 may be configured to hold the tray 604.

Further, the chassis 602 may be connected to a power supply 612 via connections 614 and 616 to provide power to the slots 608 and 610, respectively. The chassis 602 may also be connected to the communication network 618 via connections 620 and 622 to provide network connectivity to the slots 608 and 610, respectively. As such, trays 604 and 606 may be inserted into slots 608 and 610, respectively, and power supply 612 may supply power to trays 604 and 606 via connections 614 and 616, respectively. Further, trays 604 and 606 may be inserted into the slots 610 and 608, respectively, and power supply 612 may supply power to trays 604 and 606 via connections 616 and 614, respectively.

Yet further, trays 604 and 606 may be inserted into slots 608 and 610, respectively, and communication network 618 may provide network connectivity to trays 604 and 606 via connections 620 and 622, respectively. In addition, trays 604 and 606 may be inserted into slots 610 and 608, respectively, and communication network 618 may provide network connectivity to trays 604 and 606 via connections 622 and 620, respectively. The communication network 618 may, for example, take the form of the one or more communication networks 508, possibly including one or more of a data network and a cellular network. In some embodiments, the communication network 618 may provide a network port, a hub, a switch, or a router that may be connected to an Ethernet link, an optical communication link, a telephone link, among other possibilities.

In practice, the tray 604 may be inserted into the slot 608 and the tray 606 may be inserted into the slot 610. During operation, the trays 604 and 606 may be removed from the slots 608 and 610, respectively. Further, the tray 604 may be inserted into the slot 610 and the tray 606 may be inserted into the slot 608, and the system 600 may continue operating, possibly based on various data buffering mechanisms of the system 600. Thus, the capabilities of the trays 604 and 606 may facilitate uptime and the availability of the system 600 beyond that of traditional or general servers that are required to run without interruptions. As such, the server trays 604 and/or 606 facilitate fault-tolerant capabilities of the server system 600 to further extend times of operation. In some instances, the server trays 604 and/or 606 may include specialized hardware, such as hot-swappable hard drives, that may be replaced in the server trays 604 and/or 606 during operation. As such, the server trays 604 and/or 606 may reduce or eliminate interruptions to further increase uptime.

FIG. 6B illustrates an exemplary tray 604 configured to support one or more components, according to an embodiment. The tray 604, possibly also referred to as the server tray 604, may take the form of the tray 604 described in relation to FIG. 6A. Further, the tray 606 may also take the form of the tray 604. As shown, the tray 604 may include a tray base 630 that may include the bottom surface of the tray 604. The tray base 630 may be configured to support multiple components such as the hard drives described above and a main computing board connecting one or more components 632-640. The tray 604 may include a connection 626 that may link to the connections 614 or 616 to supply power to the tray 604. The tray 604 may also include a connection 628 that may link to the connections 620 or 622 to provide network connectivity to the tray 604. The connections 626 and 628 may be positioned on the tray 604 such that upon inserting the tray 604 into the slot 608, the connections 626 and 628 couple directly with the connections 614 and 620, respectively. Further, upon inserting the tray 604 into the slot 610, the connections 626 and 628 may couple directly with connections 616 and 622, respectively.

In some embodiments, the tray 604 may include a processor component 632, a memory component 634, a data storage component 636, a communication component and/or interface 638, that may, for example, take the form of the hardware processor 512, the non-transitory memory 514, the non-transitory data storage 516, and the communication interface 518, respectively. Further, the tray 604 may include the data engine component 640 that may take the form of the system 100.

As shown, the connections 626 and 628 may be configured to provide power and network connectivity, respectively, to each of the components 632-640. In some embodiments, one or more of the components 632-640 may perform operations described herein, illustrated by the accompanying figures, and/or otherwise contemplated. In some embodiments, the components 632-640 may execute instructions on a non-transitory, computer-readable medium to cause the system 600 to perform such operations.

As shown, the processor component 632 may take the form of a multi-purpose processor, a microprocessor, a special purpose processor, a digital signal processor (DSP). Yet further, the processor component 632 may take the form of an application specific integrated circuit (ASIC), a programmable system on chip (PSOC), field-programmable gate array (FPGA), and/or other types of processing components. For example, the processor component 632 may be configured to receive a request for a list of users to contact based on an input to a graphical user interface of a client device, such as the client device 504.

The data engine 640 may perform a number of operations. The operations may include collect historical data 114 from one or more data sources. The operations may also include determining one or more feature vectors that represent the learned user behaviors. The operations may include generating one or more models 116 associated with the learned user behaviors. The operations may include various other processes described above.

In some embodiments, the processor component 632 may be configured with a Unix-based operating system, possibly to support scalability with various other servers and/or data infrastructures. In particular, the processor component 632 may be configured to be scalable with other servers of various forms that may, for example, include server trays, blades, and/or cartridges similar to the server trays 604 and/or 606. In some instances, the processor component 632 may be configured with scalable process architectures, including, reduced instruction set architectures. In some instances, the processor component 632 may be compatible with various legacy systems such that the processor component 632 may receive, read, and/or execute instruction sets with legacy formats and/or structures. As such, the processor component 632 generally has capabilities beyond that of traditional or general-purpose processors.

The database engine component 640 may also include one or more secure databases to track numerous user accounts. For example, the database engine component 640 may include secured databases to detect data associated with the user accounts. In particular, the database engine component 640 may perform searches based on numerous queries, search multiple databases in parallel, and detect the data simultaneously and/or consecutively. Thus, the database engine component 640 may relieve various bottlenecks encountered with traditional or general-purpose servers.

Any two or more of the components 632-640 described above may be combined. For example, two or more of the processor component 632, the memory component 634, the data storage component 636, the communication component and/or interface 638, and/or the data engine component 640 may be combined. Further, the combined component may take the form of one or more processors, DSPs, SOCs, FPGAs, and/or ASICs, among other types of processing devices and/or components described herein. For example, the combined component may take the form an SOC that integrates various other components in a single chip with digital, analog, and/or mixed-signal functions, all incorporated within the same substrate. As such, the SOC may be configured to carry out various operations of the components 632-640.

The components 632-640 described above may provide advantages over traditional or general-purpose servers and/or computers. For example, the components 632-640 may enable the system 600 to transfer data over the one or more communication networks 618 to numerous other client devices, such as the client devices 104 and/or 106. In particular, the components 632-640 may enable the system 600 to determine data associated with numerous users locally from a single server tray 604. In some instances, configuring a separate and/or dedicated processing component 632 to determine lists of users to contact may optimize operations beyond the capabilities of traditional servers including general-purpose processors. As such, the average wait time for the client device 504 to display lists of users to contact may be minimized to a fraction of a second.

It can be appreciated that the system 600, the chassis 602, the trays 604 and 606, the slots 608 and 610, the power supply 612, the communication network 618, and the components 632-640 may be deployed in other ways. The operations performed by components 632-640 may be combined or separated for a given embodiment and may be performed by a greater number or fewer number of components or devices. Further, one or more components or devices may be operated and/or maintained by the same or different users.

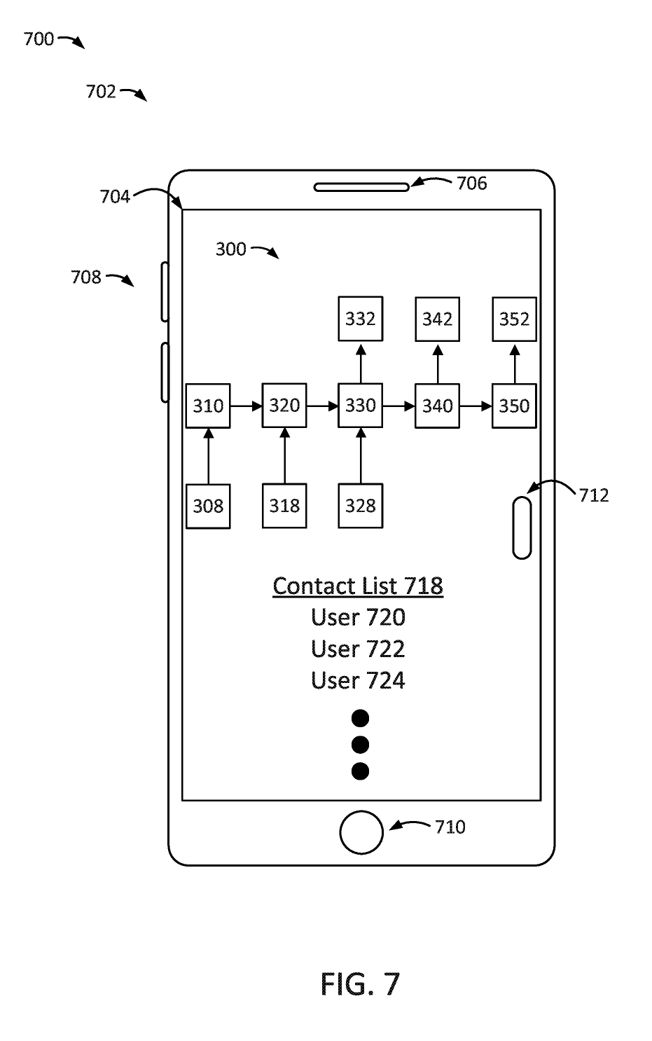

FIG. 7 illustrates an exemplary system 700 with a client device 702, according to an embodiment. In some embodiments, the system 700, possibly referred to a smartphone system 700, may include aspects of the system 500 such that the client device 702 takes the form of the client device 504. As shown, the smartphone system 700 may include a display or an input/output (I/O) interface 704 that takes the form of the I/O interface 530 described above. The smartphone system 700 may also include a speaker/microphone 706, one or more side buttons 708, and a button 710, among other possible hardware components. The smartphone system 700 may also include a non-transitory machine-readable medium having stored thereon machine-readable instructions executable to cause a machine, such as the smartphone system 700, to perform the operations described herein. The smartphone system 700 may also include one or more hardware processors that may take the form of the processor 534. The one or more hardware processors may be coupled to the non-transitory machine-readable medium, e.g., the data storage 536, and configured to read the instructions to cause the smartphone system 700 to perform operations.

In some embodiments, the client device 702 may display aspects of the neural network 300 on the graphical user interface 704. As shown, the client device 702 may display the input nodes 308, 218, and/or 328, the hidden nodes 310, 320, 330, 340, and/or 350, and the output nodes 332, 342, and/or 352. In particular, the scroll bar 712 may be moved to display various aspects of the RNN 300 on the I/O interface 704. Further, the I/O user interface 704 may receive inputs such that the contact list 718 may be generated based on the RNN 330. The contact list may include the users 720, 722, 724, and/or other user contemplated with the ellipses. Further, the users 720, 722, and/or 724 may be ranked such that the user 720 is the most likely to be contacted based on outputs from the RNN 300.

The present disclosure, the accompanying figures, and the claims are not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure.

1. A system, comprising:
a non-transitory memory; and
one or more hardware processors coupled to the non-transitory memory and configured to read instructions from the non-transitory memory to cause the system to perform operations comprising:
collecting historical data from one or more data sources;
learning user behaviors based at least on iterations of the collected historical data with a recurrent neural network (RNN) with long short term memory (LSTM);
determining one or more feature vectors that represents the learned user behaviors; and
generating one or more models associated with the learned user behaviors based at least on the one or more determined vectors.

2. The system of claim 1, wherein the operations further comprise:
generating a feature matrix based at least on the learned user behaviors, wherein the feature matrix indicates historical contacts with one or more users, and
wherein the one or more models generated comprises a contact model configured to predict additional contacts with the one or more users.

3. The system of claim 2, wherein the contact model indicates responses of the one or more users based at least on the historical contacts, and wherein the operations further comprises:
predicting the additional contacts with the one or more users based at least on the responses of the one or more users indicated by the contact model.

4. The system of claim 1, wherein the operations further comprise:
generating a feature matrix based at least on the learned user behaviors, wherein the feature matrix indicates historical purchases by one or more users, and
wherein the one or more models generated comprises a purchase model configured to predict additional purchases by the one or more users.

5. The system of claim 1, wherein the operations further comprise:
generating a feature matrix based at least on the learned user behaviors, wherein the feature matrix indicates historical actions by one or more users, and
wherein the one or more models generated comprises a detection model configured to detect fraudulent actions by the one or more users.

6. The system of claim 1, wherein the RNN with the LSTM further comprises an input layer, a hidden layer, and an output layer, wherein the operations further comprise:
transferring the collected historical data from the input layer to the hidden layer, wherein the collected historical data converts to second data based at least on transferring the collected historical data from the input layer to the hidden layer; and
transferring the second data from the hidden layer to the output layer, wherein the second data converts to third data based at least on transferring the second data from the hidden layer to the output layer; and
outputting the third data from the output layer, wherein the user behaviors are learned based at least on the third data.

7. The system of claim 1, wherein the operations further comprise:
generating a contact list based at least on the one or more models associated with the learned user behaviors, wherein the contact list indicates one or more users to contact based at least on the one or more models; and
displaying the contact list on a mobile device.

8. A non-transitory machine-readable medium having stored thereon machine-readable instructions executable to cause a machine to perform operations comprising:
determining a first hidden-layer transfer from first hidden nodes of a first iteration to second hidden nodes of a second iteration in a recurrent neural network (RNN) with long short term memory (LSTM);
determining a second hidden-layer transfer from the second hidden nodes to third hidden nodes of a third iteration in the RNN with the LSTM;
determining a output transfer from the third hidden nodes to output nodes of the third iteration in the RNN with the LSTM; and
learning user behaviors based at least on the output transfer from the third hidden nodes to the output nodes.

9. The non-transitory machine-readable medium of claim 8, wherein the operations further comprise:
transferring collected data from one or more data sources to first input nodes, second input nodes, and third input nodes,
wherein the first iteration comprises a first input-layer transfer from the first input nodes to the first hidden nodes,
wherein the second iteration comprises a second input-layer transfer from the second input nodes to the second hidden nodes, and
wherein the third iteration comprises a third-input layer data transfer from the third input nodes to the third hidden nodes.

10. The non-transitory machine-readable medium of claim 9, wherein the operations further comprise:
generating data for the second hidden-layer transfer based at least on the first hidden-layer transfer and the second input-layer transfer from the second input nodes.

11. The non-transitory machine-readable medium of claim 9, wherein the operations further comprise:
generating data for the output transfer based at least on the second hidden-layer transfer and the third input-layer transfer from the second input nodes.

12. The non-transitory machine-readable medium of claim 8, wherein the operations further comprise:
generating a contact list based at least on the learned user behaviors associated with the output transfer from the third hidden nodes to the output nodes, wherein the contact list indicates one or more users to contact based at least on the one or more models; and
displaying the contact list on a mobile device.

13. The non-transitory machine-readable medium of claim 8, wherein the operations further comprise:
receiving, by the third hidden nodes, a first cell state based at least on the second hidden-layer transfer from the second hidden nodes to the third hidden nodes;
receiving, by the third hidden node, an input based on a third input-layer transfer from third input nodes to the third hidden nodes;
determining a second cell state based at least on the first cell state and the input from the third input nodes, wherein the output transfer is determined based at least on the second cell state.

14. A method, comprising:
determining a first hidden-layer transfer from first hidden nodes of a first iteration to second hidden nodes of a second iteration in a recurrent neural network (RNN) with long short term memory (LSTM);
determining a second hidden-layer transfer from the second hidden nodes to third hidden nodes of a third iteration in the RNN with the LSTM;
determining a first output transfer from the third hidden nodes to third output nodes of the third iteration; and
learning user behaviors based at least on the first output transfer from the third hidden nodes to third output nodes.

15. The method of claim 14, further comprising:
generating output data for the first output transfer based at least on the second hidden-layer transfer and a third input transfer from third input nodes to the third hidden nodes of the third iteration.

16. The method of claim 14, further comprising:
determining a third hidden-layer transfer from the third hidden nodes to fourth hidden nodes of a fourth iteration in the RNN with the LSTM;
determining a second output transfer from the fourth hidden nodes to fourth output nodes of the fourth iteration, wherein the user behaviors are learned based at least on the second output transfer from the fourth hidden nodes to the fourth output nodes.

17. The method of claim 14, further comprising:
determining a fourth hidden layer transfer from the fourth hidden nodes to fifth hidden nodes of a fifth iteration in the RNN with the LSTM;
determining a third output transfer from the fifth hidden nodes to fifth output nodes of the fifth iteration, wherein the user behaviors are learned based at least on the third output transfer.

18. The method of claim 14, further comprising:
transferring a first cell state to one or more pointwise operations based at least on the second hidden-layer transfer;
determining a second cell state based at least on the first cell state transferred to the one or more pointwise operations and one or more layers of the third hidden nodes; and
wherein the user behaviors are learned based at least on the second cell state.

19. The method of claim 18, wherein the one or more layers of the hidden nodes comprises at least one sigmoid layer and at least one tan h layer, wherein the user behaviors are learned based at least on outputs from the at least one sigmoid layer and the at least one tan h layer.

20. The method of claim 14, further comprising:
generating a contact list associated with the learned user behaviors based at least on output data from the third output nodes, wherein the contact list indicates one or more users to contact based at least on the output data; and
displaying the contact list on a mobile device.
